(19) United States
(12) Patent Application Publication
(10) Pub. No.: US 2006/0070471 A1
(43) Pub. Date: Apr. 6, 2006

(54) Gear transmission system

(75) Inventor: Shinya Matsuoka, Kumamoto (JP)

Correspondence Address: ARENT FOX PLLC, 1050 CONNECTICUT AVENUE, N.W., SUITE 400, WASHINGTON, DC, 20036, US

(73) Assignees: MUSASHI SEIMITSU INDUSTRY CO., LTD.; KYUSHU MUSASHI SEIMITSU KABUSHIKI KAISHA

(21) Appl. No.: 11/235,550

(22) Filed: Sep. 27, 2005

(30) Foreign Application Priority Data
Sep. 29, 2004 (JP) 2004-283499

(51) Int. Cl. F16H 1/14

(52) U.S. Cl. 74/417

(57) ABSTRACT

A gear transmission system includes: first and second transmission shafts rotatably supported in a transmission case with axes thereof intersecting each other; and first and second bevel gears joined by spline press-fitting to end portions of the first and second transmission shafts that are in proximity to each other, the first and second bevel gears meshing with each other. The first and second transmission shafts have abutment portions formed on the end portions thereof that are in proximity to each other. The abutment portions abut against each other when the transmission shafts move relatively in the axial direction so as to be close to each other, thereby restricting the relative movement.

### RELATED APPLICATION DATA

The present invention is based upon Japanese priority application No. 2004-283499, which is hereby incorporated in its entirety herein by reference.

### BACKGROUND OF THE INVENTION

1. Field of the Invention

The present invention relates to an improvement of a gear transmission system that includes: first and second transmission shafts rotatably supported in a transmission case with axes thereof intersecting each other; and first and second bevel gears joined by spline press-fitting to end portions of the first and second transmission shafts that are in proximity to each other, the first and second bevel gears meshing with each other.

2. The Related Art

Such a gear transmission system is already known, as disclosed in Japanese Patent Application Laid-open No. 8-133164.

As shown in FIG. 3, a conventional gear transmission system has a structure in which a bevel gear 04 is disposed adjacent to a bearing 06 axially immovably mounted in a transmission case 01, and the bearing 06 and the bevel gear 04 are sandwiched between a positioning flange 02a and an axial movement-stopping member such as a nut N fixedly attached to the transmission shaft 02, the positioning flange 02a being formed on the transmission shaft 02 so as to abut against a small-diameter-side end face of the bevel gear 04. With this structure, even if the press-fitting joining force of the spline-coupled portion between the transmission shaft 02 and the bevel gear 04 is degraded, it is possible to prevent the transmission shaft 02 from moving uncontrollably in the axial direction.

### SUMMARY OF THE INVENTION

It is an object of the present invention to provide a gear transmission system in which unexpected uncontrollable axial movement of a transmission shaft can be reliably prevented as in the conventional arrangement, while simplifying the structure and decreasing the number of assembly steps for cost reduction which has been widely demanded in recent years.

In order to achieve the above-mentioned object, according to a first feature of the invention, there is provided a gear transmission system comprising: first and second transmission shafts rotatably supported in a transmission case with axes thereof intersecting each other; and first and second bevel gears joined by spline press-fitting to end portions of the first and second transmission shafts that are in proximity to each other, the first and second bevel gears meshing with each other, wherein the first and second transmission shafts have abutment portions formed on the end portions thereof that are in proximity to each other, the abutment portions abutting against each other when the transmission shafts move relatively in the axial direction so as to be close to each other, thereby restricting the relative movement.

With the first feature of the present invention, when the first and second transmission shafts transmit rotational torque to each other via the first and second bevel gears, if the press-fitting joining force of the spline-coupled portion between one of the transmission shafts and the bevel gear is degraded to cause slipping in the axial direction in the spline-coupled portion and make one of the transmission shafts approach the other transmission shaft, the abutment portions formed integrally with the two transmission shafts abut against each other, thereby restricting the axial movement of said one of the transmission shafts. In this way, when the press-fitting joining force of the spline-coupled portion is degraded, the first and second transmission shafts can mutually prevent unexpected uncontrollable axial movement by virtue of interaction therebetween, so that it is unnecessary to specially provide an axial movement-stopping member such as a nut on each transmission shaft, thus achieving a simplification of the structure and a reduction in the number of assembly steps.

According to a second feature of the present invention, in addition to the first feature, the first and second transmission shafts have positioning flanges formed thereon, the positioning flanges supporting small-diameter-side end faces of the first and second bevel gears; and the positioning flanges have conical faces formed on outer peripheries thereof as the abutment portions, the conical faces having generatrices parallel to a bisector of an angle formed between the axes of the first and second transmission shafts.

With the second feature of the present invention, the positioning flanges supporting the small-diameter-side end faces of the first and second bevel gears are formed, and the conical faces having generatrices parallel to the bisector of the angle formed between the axes of the first and second transmission shafts are formed on the outer peripheries of the positioning flanges to serve as the abutment portions. Therefore, not only can the conical faces suppress the contact surface pressure to a low level, but they can also roll against each other accompanying rotation of the transmission shafts, thus guaranteeing normal meshed rotation of the first and second bevel gears while minimizing mutual wear.

The above-mentioned object, other objects, characteristics, and advantages of the present invention will become apparent from a preferred embodiment that will be described in detail below by reference to the attached drawings.

### BRIEF DESCRIPTION OF THE DRAWINGS

FIG. 1 is a sectional plan view of a gear transmission system according to an embodiment of the present invention.

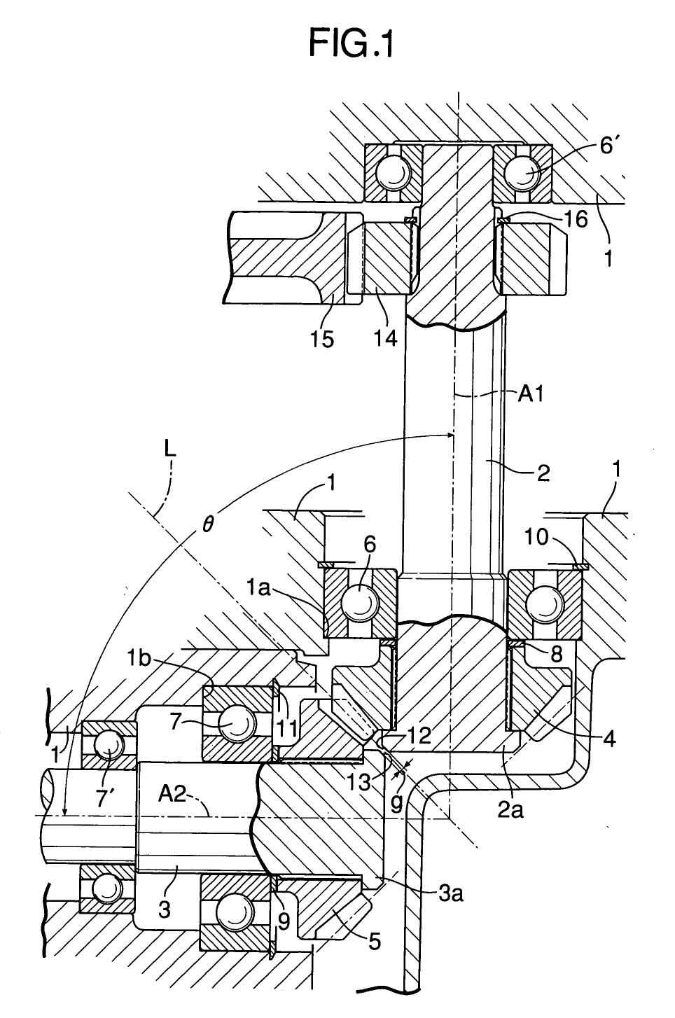

FIG. 2 is a diagram for explaining the operation of the gear transmission system.

FIG. 3 is a sectional plan view of one example of a conventional gear transmission system.

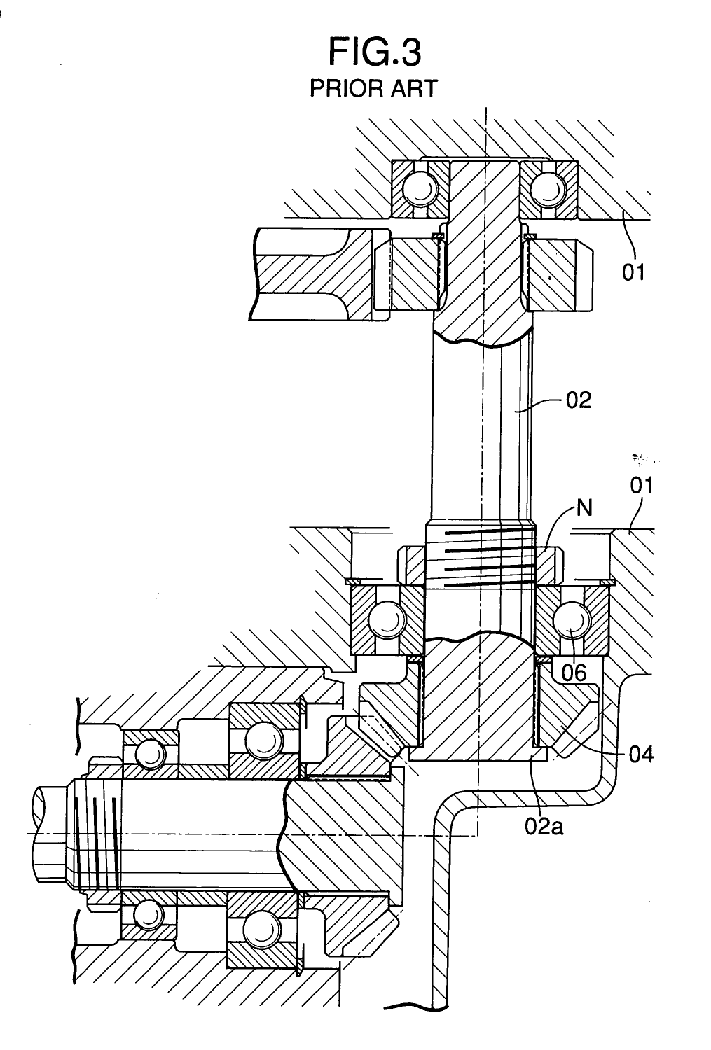

### DESCRIPTION OF PREFERRED EMBODIMENT

This gear transmission system includes: a transmission case 1; and first and second transmission shafts 2 and 3 disposed in the transmission case 1 so that axes A1 and A2 of the first and second transmission shafts 2 and 3 are perpendicular to each other with end portions thereof close to each other. The first and second transmission shafts 2 and 3 are rotatably supported in the transmission case 1 via pairs of large and small ball bearings 6, 6′; 7, 7′. Positioning flanges 2a and 3a are formed integrally with the first and second transmission shafts 2 and 3 on said end portions which are close to each other; a first bevel gear 4 is joined by spline press-fitting to the first transmission shaft 2, the first bevel gear 4 having a small-diameter-side end face thereof received by the positioning flange 2a; and a second bevel gear 5 is joined by spline press-fitting to the second transmission shaft 3, the second bevel gear 5 having a small-diameter-side end face thereof received by the positioning flange 3a and meshing with the first bevel gear 4.

The first bevel gear 4 is disposed so as to abut against an inner race of the large diameter ball bearing 6 via a thrust washer 8. An outer race of the bearing 6 is sandwiched between an annular shoulder portion 1a formed in the transmission case 1 and a circlip 10 secured to the transmission case 1, thus fixing the outer race to the transmission case 1.

The second bevel gear 5 is disposed so as to abut against an inner race of the large diameter ball bearing 7 via a thrust washer 9. An outer race of the bearing 7 is sandwiched between an annular shoulder portion 1b formed in the transmission case 1 and a circlip 11 secured to the transmission case 1, thus fixing the outer race to the transmission case 1.

Conical faces 12 and 13 are formed on outer peripheries of the positioning flanges 2a and 3a of the first and second transmission shafts 2 and 3. The conical faces 12 and 13 have generatrices parallel to a bisector L of an angle θ formed between the axes A1 and A2 of the transmission shafts 2 and 3. The conical faces 12 and 13 have a small gap g therebetween so as not to make contact with each other in a normal state in which the first and second transmission shafts 2 and 3 do not move in the axial direction. However, when the first and second transmission shafts 2 and 3 move relatively in the axial direction so as to approach each other, they abut against each other to restrict the relative movement.

A driven spur gear 14 is spline-coupled to the first transmission shaft 2 and fixed by means of a circlip 16, the driven spur gear 14 being adjacent to the inside of the small diameter bearing 6′. A drive spur gear 15 meshes with the driven spur gear 14, the drive spur gear 15 being driven by a drive shaft (not illustrated).

The operation of this embodiment is now described.

When the drive spur gear 15 drives the driven spur gear 14 to rotate the first transmission shaft 2, rotational torque is transmitted from the first bevel gear 4 to the second bevel gear 5, and then to the second transmission shaft 3.

Since the first and second bevel gears 4 and 5 are inhibited from moving in the axial direction by means of the mating bevel gear and the corresponding large diameter bearings 6 and 7, the first and second transmission shafts 2 and 3, which are joined by spline press-fitting to the first and second bevel gears 4 and 5, do not normally move in the axial direction.

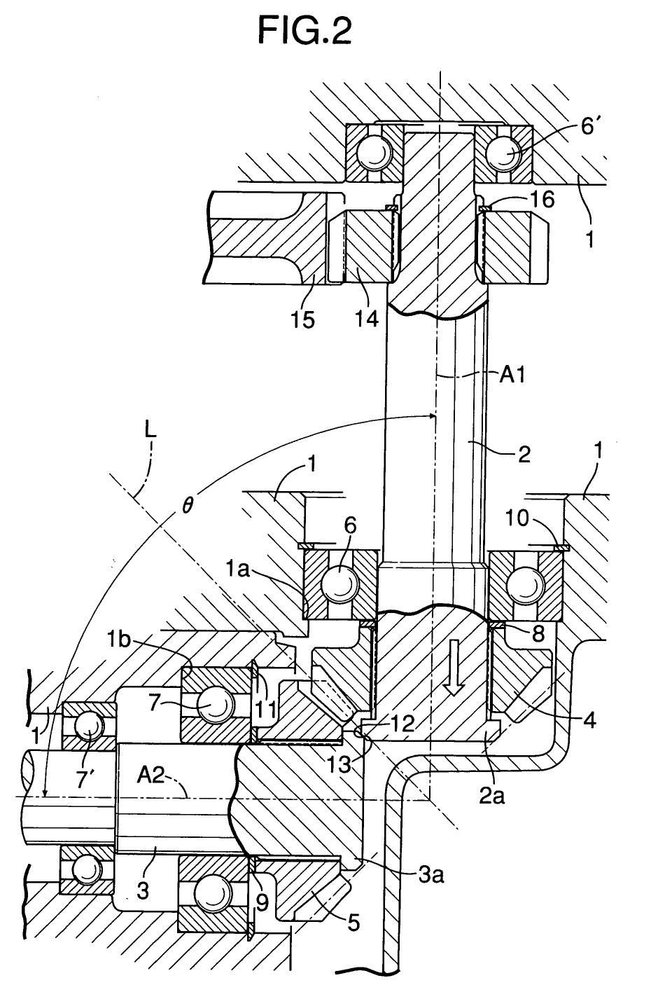

However, when, for example, the press-fitting joining force of the spline-coupled portion between the first transmission shaft 2 and the first bevel gear 4 is degraded, the spline-coupled portion might slip in the axial direction, and the first transmission shaft 2 might move in the axial direction so as to move the positioning flange 2a away from the first bevel gear 4 and approach the second transmission shaft 3. In this situation, as shown in FIG. 2, the conical face 12 on the outer periphery of the positioning flange 2a of the first transmission shaft 2 immediately abuts against the conical face 13 of the outer periphery of the positioning flange 3a of the second transmission shaft 3, thereby restricting the axial movement of the first transmission shaft 2. Therefore, it is possible to prevent the first transmission shaft 2 from moving uncontrollably in the axial direction and interfering with another object such as, for example, the transmission case 1. In this case, even if the press-fitting joining force between the first transmission shaft 2 and the first bevel gear 4 is degraded, the spline-coupled state between the two members 2 and 4 is maintained, so that no problem occurs in transmitting the rotational torque from the first transmission shaft 2 to the first bevel gear 4 and thus the torque transmission to the second transmission shaft 3 is continued.

Moreover, since the conical faces 12 and 13 of the positioning flanges 2a and 3a, which abut against each other, have the generatrices parallel to the bisector L of the angle θ formed between the axes A1 and A2 of the transmission shafts 2 and 3 as described above, not only can the mutual contact surface pressure be suppressed to a low level, but they can also roll against each other accompanying rotation of the transmission shafts 2 and 3, thus maintaining the normal meshed rotation of the first and second bevel gears 4 and 5 while minimizing mutual wear.

Axial movement of the first transmission shaft 2 in the opposite direction to the above-described direction, that is, in a direction to move away from the second transmission shaft 3, is inhibited by the positioning flange 2a abutting against the first bevel gear 4.

It is obvious that the conical faces 12 and 13 of the positioning flanges 2a and 3a abutting against each other can restrict axial movement of the second transmission shaft 3 in the same manner as described above, even if the press-fitting joining force between the second transmission shaft 3 and the second bevel gear 5 is degraded. Axial movement of the second transmission shaft 3 away from the first transmission shaft 2 is of course prevented by the positioning flange 3a abutting against the second bevel gear 5.

In this way, when the press-fitting joining force of the spline-coupled portion between the transmission shafts 2 and 3 and the corresponding bevel gears 4 and 5 is degraded, the first and second transmission shafts 2 and 3 can prevent unexpected uncontrollable mutual axial movement by virtue of the interaction between the positioning flanges 2a and 3a. Therefore, it is unnecessary to specially provide an axial movement-stopping member such as a nut on the transmission shafts 2 and 3, thus achieving a simplification of the structure and a reduction in the number of assembly steps.

Although an embodiment of the present invention has been described above, the present invention is not limited to the above-described embodiment, and can be modified in a variety of ways without departing from the subject matter of the present invention.

For example, the present invention is also applicable to a gear transmission system in which the angle at which axes A1 and A2 of first and second transmission shafts 2 and 3 intersect each other is other than 90°.

What is claimed is:

1. A gear transmission system comprising:
first and second transmission shafts rotatably supported in a transmission case with axes thereof intersecting each other; and
first and second bevel gears joined by spline press-fitting to end portions of the first and second transmission shafts that are in proximity to each other, the first and second bevel gears meshing with each other,
wherein the first and second transmission shafts have abutment portions formed on the end portions thereof that are in proximity to each other, the abutment portions abutting against each other when the transmission shafts move relatively in the axial direction so as to be close to each other, thereby restricting the relative movement.

2. The gear transmission system according to claim 1, wherein the first and second transmission shafts have positioning flanges formed thereon, the positioning flanges supporting small-diameter-side end faces of the first and second bevel gears, and wherein the positioning flanges have conical faces formed on outer peripheries thereof as the abutment portions, the conical faces having generatrices parallel to a bisector of an angle formed between the axes of the first and second transmission shafts.
